(19) United States
(12) Patent Application Publication
(10) Pub. No.: US 2021/0312236 A1
(43) Pub. Date: Oct. 7, 2021

(54) SYSTEM AND METHOD FOR EFFICIENT MACHINE LEARNING MODEL TRAINING

(71) Applicant: Cherry Labs, Inc., Wilmington, DE (US)

(72) Inventors: Maksim Goncharov, Redwood City, CA (US); Vasiliy Morzhakov, Moscow (RU); Stanislav Veretennikov, San Francisco, CA (US)

(21) Appl. No.: 17/353,281

(22) Filed: Jun. 21, 2021

Related U.S. Application Data
(63) Continuation of application No. PCT/US21/24306, filed on Mar. 26, 2021.
(60) Provisional application No. 63/001,862, filed on Mar. 30, 2020.

(51) Int. Cl. G06K 9/62; G06K 9/00; G06N 20/00; G06T 7/73

(52) U.S. Cl. CPC G06K 9/6257; G06T 7/75; G06N 20/00; G06K 9/00342

(57) ABSTRACT

A new approach is proposed to support efficient machine learning (ML) model training for a monitoring system using only a few images from a video image stream collected by a camera. First, a set of 2-dimensional (2D) images of a person is produced from the collected video image stream at various poses and/or positions to identify the person's ordinary/normal activities at the monitored location. The set of 2D images is then transferred under a plurality of contexts representing different orientations and/or heights of the camera with derived embedding codes to train one or more ML models. Once trained, the one or more ML models are applied to filter the video stream at the monitored location and to alert an administrator if an abnormal activity is detected from the video streams captured at the monitored location based on the trained one or more ML models of the person's normal activity.

### CROSS-REFERENCE TO RELATED APPLICATIONS

This application is a continuation application of U.S. patent application Ser. No. PCT/US21/24306, filed Mar. 26, 2021, entitled “System and Method for Efficient Machine Learning Model Training,” which claims the benefit of U.S. Provisional Patent Application No. 63/001,862, filed Mar. 30, 2020. Both of which are incorporated herein in their entireties by reference.

### BACKGROUND

A variety of security, monitoring and control systems equipped with a plurality of cameras and/or sensors have been used to detect various threats such as intrusions, fire, smoke, flood, etc. For a non-limiting example, motion detection is often used to detect intruders in vacated homes or buildings, wherein the detection of an intruder may lead to an audio or silent alarm and contact of security personnel. Video monitoring is also used to provide additional information about personnel living in an assisted living facility.

Currently, the security monitoring systems can be artificial intelligence (AI) or machine learning (ML)-driven, which process video and/or audio stream collected from the video cameras and/or other sensors via a processing unit pre-loaded with one or more ML training models configured to differentiate and detect abnormal activities/events from the normal daily routines at a monitored location. However, the amount of data needed to predict and to differentiate an abnormal activity/event from a normal activity typically requires immense amount of training and verification data in order for the ML models to achieve a reasonable level of accuracy, which can be very time-consuming. Consequently, ML model training and validation has become a bottleneck for the AI-driven security monitoring systems.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts an example of a system diagram to support efficient machine learning model training in accordance with some embodiments.

FIG. 2 depicts an example of a technical workflow of the video stream analysis and image extraction process for the training of the ML models in accordance with some embodiments.

FIG. 3 depicts an example of the architecture of a disentanglement network used during the disentanglement stage of the video stream analysis and image extraction process in accordance with some embodiments.

FIG. 4 depicts an example of a transferring network comprising a set of conditional autoencoders used during the transferring and embedding stage of the video stream analysis and image extraction process in accordance with some embodiments.

FIG. 5 depicts an example for estimating the height and orientation measured in terms of rotation angle of each skeleton in accordance with some embodiments.

FIG. 6 depicts a flowchart of an example of a process to support efficient machine learning model training in accordance with some embodiments.

### DETAILED DESCRIPTION OF EMBODIMENTS

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

A new approach is proposed that contemplates systems and methods to support efficient machine learning (ML) model training for a monitoring system using only a few images or data points from a video image stream collected by a camera. First, a set of 2-dimensional (2D) images (e.g., skeletons) of a person (e.g., human body) is produced from the collected video image stream at various poses and/or positions of the location being monitored, wherein the set of 2D images is critical in identifying the person's ordinary/normal activities at the monitored location. The set of 2D images is then transferred under a plurality of contexts representing different orientations and/or heights of the camera with derived embedding codes to train one or more ML models for the normal activity of the person. Once trained, the one or more ML models are applied by the monitoring system to filter one or more video streams of captured daily activities at the monitored location and to alert an administrator if an abnormal activity is recognized and detected from the video streams captured at the monitored location based on the trained one or more ML models of the person's normal activity.

Under the proposed approach of training the ML models with only a few human images, the number of images/datapoint needed to train the ML model in a neural network used for security monitoring is drastically reduced. As a result, the proposed approach effectively cuts down the amount of time, data, and processing power needed to train the complex AI models. In addition, the proposed approach also increases the accuracy of identifying the abnormal activities from daily normal activities of persons at the monitored location.

When applied specifically to a non-limiting example of home monitoring pertinent to elderly care, the proposed approach enables all normal routine activities/actions/behaviors of the elders to be quickly learned by the ML models in order to ascertain the daily normal behavior, which will be tagged accordingly. Although the daily normal activities are usually immensely complex to learn, analyze and predict, the proposed approach is able to drastically reduce the time it takes to train and deploy the ML model for a neural network by only using a few 2D images from a captured video stream. As such, when integrated into a security monitoring system, the trained ML models can effectively and efficiently detect subtle abnormal trends in the daily activities of the elders such as a person is walking slower, starting to limp over a period of time (e.g., 6 to 12 months), waking up more frequently during the night, etc. In some embodiments, the ML models can be quickly trained to detect certain types of activities or actions that are specific to a particular person, like falling, coughing, distress, etc.

Although security monitoring systems have been used as non-limiting examples to illustrate the proposed approach to efficient ML model training, it is appreciated that the same or similar approach can also be applied to efficiently train and validate ML models used in other types of AI-driven systems.

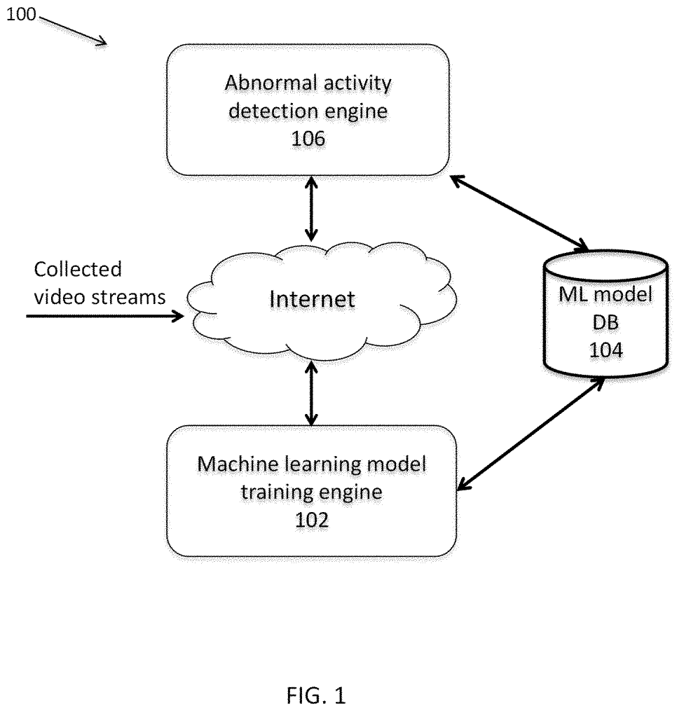

FIG. 1 depicts an example of a system diagram 100 to support efficient machine learning model training. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

In the example of FIG. 1, the system 100 includes one or more of a machine learning (ML) model training engine 102, a ML model database 104, and an abnormal activity detection engine 106. These components in the system 100 each runs on one or more computing units/appliances/devices/hosts (not shown) each with software instructions stored in a storage unit such as a non-volatile memory (also referred to as secondary memory) of the computing unit for practicing one or more processes. When the software instructions are executed, at least a subset of the software instructions is loaded into memory (also referred to as primary memory) by one of the computing units, which becomes a special purposed one for practicing the processes. The processes may also be at least partially embodied in the computing units into which computer program code is loaded and/or executed, such that, the host becomes a special purpose computing unit for practicing the processes.

In the example of FIG. 1, each computing unit can be a computing device, a communication device, a storage device, or any computing device capable of running a software component. For non-limiting examples, a computing device can be but is not limited to a server machine, a laptop PC, a desktop PC, a tablet, a Google's Android device, an iPhone, an iPad, and a voice-controlled speaker or controller. Each computing unit has a communication interface (not shown), which enables the computing units to communicate with each other, the user, and other devices over one or more communication networks following certain communication protocols, such as TCP/IP, http, https, ftp, and sftp protocols. Here, the communication networks can be but are not limited to, Internet, intranet, wide area network (WAN), local area network (LAN), wireless network, Bluetooth, WiFi, and mobile communication network. The physical connections of the network and the communication protocols are well known to those of skilled in the art.

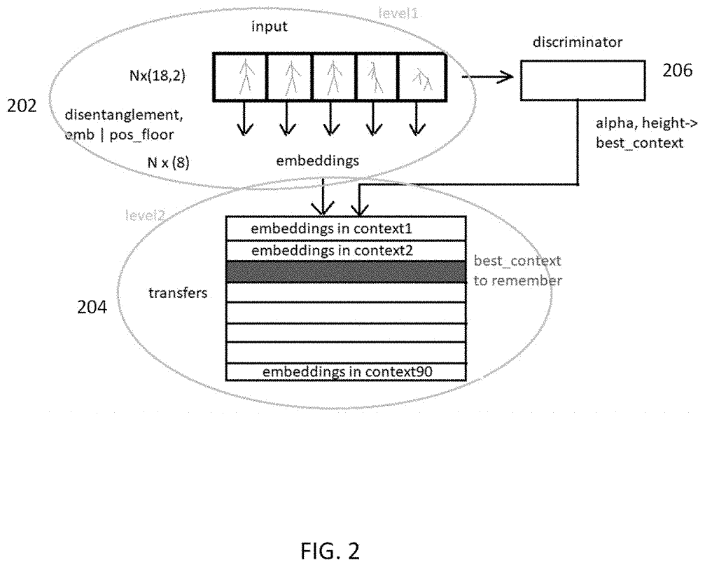

In the example of FIG. 1, the ML model training engine 102 is configured to accept a video image stream collected by one or more video cameras (not shown) and/or other sensors at a monitored location, wherein the captured video stream includes 3-dimensional (3D) information/data of a plurality of poses and/or positions (e.g., on the floor) of a person conducting a normal routine activity at the monitored location. In some embodiments, the video image stream is collected by the video cameras and/or sensors in real time. In some embodiments, the video image stream was previously collected by the video cameras and/or sensors, stored in a storage medium (not shown), and retrieved by the ML model training engine 102 for analysis. Based on the 3D information, the ML model training engine 102 is configured to analyze the collected video stream to extract a set of (one or more) 2-dimensional (2D) images and to train one or more ML models to detect abnormal human activities at the monitored location. In some embodiments, the ML model training engine 102 is configured to produce (e.g., by projecting) a set of 2D skeletons (human stick figures) of the person representing a set of different poses, orientations, positions, and heights in relation to a floor from the 3D information. The ML model training engine 102 is then configured to transfer each of the 2D skeletons to a plurality of different contexts, which include but are not limited to angles, orientations and/or heights of the camera, with corresponding/derived embedding codes to train the ML models. FIG. 2 depicts an example of a technical workflow of the video stream analysis and image extraction process for the training of the ML models, wherein the process includes two analysis stages:
1) Disentanglement stage 202, where a set of skeletons representing a person's postures and positions is disentangled/extracted from the input video stream. Corresponding embedding codes of the skeletons are also derived.
2) Transferring and embedding stage 204, where the set of skeletons are transferred into a plurality of possible contexts representing different orientations and heights of the camera with the corresponding embedding codes, wherein the possible contexts are invariant to the positions of the person.
   In some embodiments, a trained discriminator 206 is utilized by the ML model training engine 102 to estimate in which of the plurality of contexts each of the plurality of skeletons is present in the input data in order to transfer each of the skeletons with the proper context. In some embodiments, the best matching context as well as a sequence of the embedding codes for the one or more ML models to recognize an activity afterwards is identified and marked.

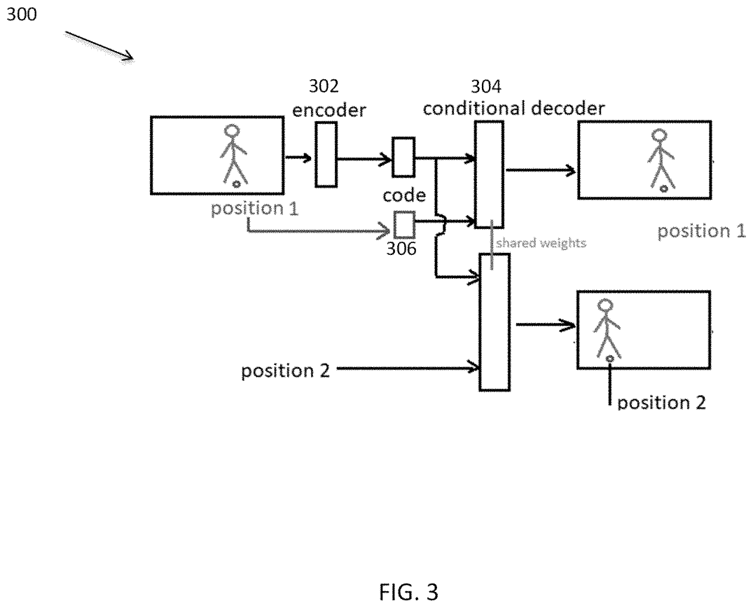

FIG. 3 depicts an example of the architecture of a disentanglement network 300 used during the disentanglement stage 202 of the video stream analysis and image extraction process. As shown in the example of FIG. 3, the disentanglement network 300 comprises an encoder 302 and a conditional decoder 304, wherein the calculation scheme is in the following sequence:

Input X->encoder 302->code z (embedding)->conditional decoder 304 (e.g., position on the floor)->output X′
In some embodiments, the input data to the disentanglement network 300 includes poses/postures of the 2D skeletons of the person each represented by a vector (X, Y), wherein X denotes the number of joints of the skeleton of the person and Y denotes the number estimated positions of the person at the monitored location (e.g., on the floor in a room) as captured in the video stream. For a non-limiting example, a vector (18,2) indicates that the skeleton of the person has 18 count of joints and 2 estimated positions. In some embodiments, the encoder 302 is configured to extract and derive the embedding codes 306 from the input vector. One property of the embedding codes is that they do not depend on the position of the person on the floor at the monitored location.

During training of the disentanglement network 300, 2D skeletons of people with the same pose are generated from 3D data in the captured input video stream into different positions on the floor with the embedding codes 306. In some embodiments, a conditional decoder 304 is configured to decode the embedding codes 306 and to reconstruct the skeletons. In some embodiments, there are two types of samples and two corresponding reconstruction pipelines:
1) reconstruction of the input position into the same position (autoencoder mode);
2) reconstruction of the input into another position on the floor.
   In some embodiments, both of these two pipelines are used by the disentanglement network 300 for backward loss propagation to determine training weights for the ML models. As a result, the positions of the person on the floor and the poses of the person are disentangled, wherein the positions are 2D vectors and the poses are coded into an embedding 8D code, which is a vector coordinate in an 8-dimensional latent space. Here, the latent space refers to an abstract multi-dimensional space containing feature values that we cannot interpret directly, but which encodes a meaningful internal representation of externally observed events. In some embodiments, the encoder 302 and the conditional decoder 304 are fully-connected in the disentanglement network 300 with one hidden layer, wherein condition is concatenated with the embedding codes as input for the conditional decoder 304. The result/output of the disentanglement network 300 includes one or more of the person's pose embedding, position on the floor, and adequacy of the input video stream for the person being monitored.

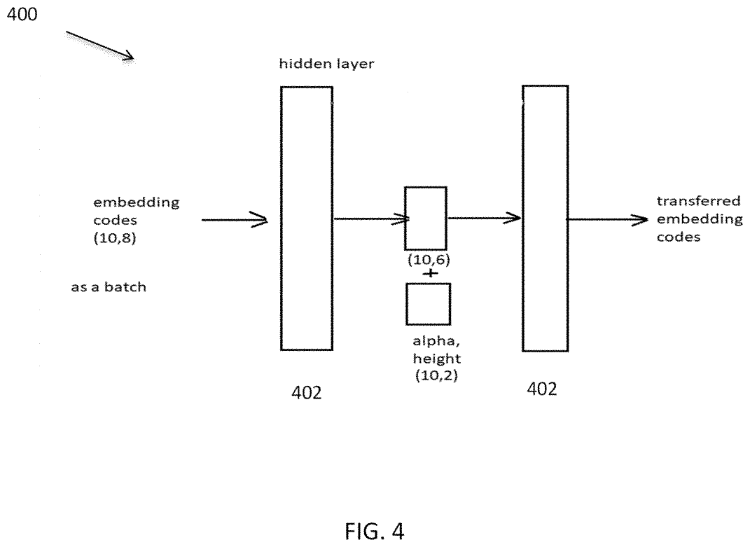

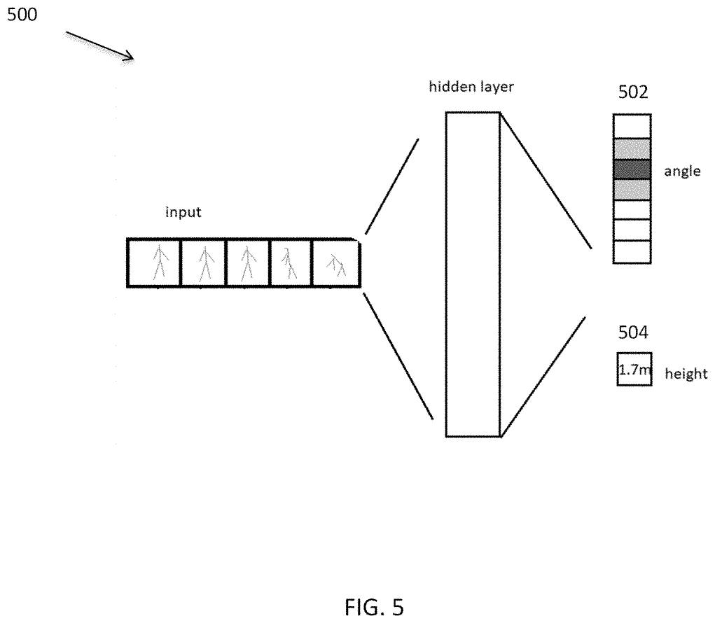

FIG. 4 depicts an example of a transferring network 400 comprising a set of conditional autoencoders 402s used during the transferring and embedding stage 204 of the video stream analysis and image extraction process, which transfers animations of the skeletons to different orientations with their embedding codes. In some embodiments, the transferring network 400 is configured to transfer a sequence of the embedding codes of the skeletons from the disentanglement stage 202 into different possible contexts based on the knowledge of which context each embedding code of the skeleton should be associated with. In some embodiments, each conditional autoencoder 402 is configured to train a discriminator 500 as depicted by the example in FIG. 5 to estimate the height and orientation measured in terms of rotation angle of each skeleton. As shown by the example in FIG. 5, the angle output from the discriminator 500 is presented by a heatmap 502 as required by the cyclical nature of the rotation angles. The height output from the discriminator 500 is presented as one component vector 504. For a non-limiting example, a standing up skeleton can be transferred to a face and a profile representation by training 90 autoencoders, which correspond to 18 angles×5 heights. In some embodiments, the discriminator 500 is configured to estimate and mark the best matching context for the skeleton.

In some embodiments, the ML model training engine 102 is configured to transform each embedding 8D code to another space by a 8×8 matrix, which weights are trained by triplet loss on some pre-specified set of actions. For a non-limiting example, a few animations of sitting down, standing up, fallings are chosen for training. In some embodiments, the ML model training engine 102 is configured to reconstruct the 3D information of the person's body in space based on the identified skeletons of the person. In some embodiments, the ML model training engine 102 is configured to utilize and adjust one or more of orientation, height, and/or lens distortion of the camera used to capture the input video stream to train the ML models of the neural network to understand different (e.g., hundreds) variations of the person's posture, e.g., how the person stands, sits, lays down, etc. As discussed above, the ML model training engine 102 takes a few simple skeletons from the camera-captured input video streams as input and generates 2D joints of the skeleton in the images as output. In some embodiments, the ML model training engine 102 is configured to analyze each skeleton based on the ML models of the neural network to predict a depth position of the person relative to the camera and generate scores for all possible postures. Based on the analysis, the ML model training engine 102 is configured to generate a projection of a center of mass of the person on the floor and the most relevant posture of the skeleton.

To recognize an activity or action by a person after the one or more ML models have been trained, in some embodiments, the transferring network 400 is configured to transfer the one or more ML models of the person's normal or routine activities including a sequence of the embedding codes of the skeletons plus an index of the best matching context estimated by the discriminator 500 to the abnormal activity detection engine 106 directly. In some embodiments, the one or more trained ML models are saved to a ML model database 104, which is configured to maintain the one or more ML models and provide the ML models to the abnormal activity detection engine 106 as needed for activity detection.

In the example of FIG. 1, the abnormal activity detection engine 106 is configured to continuously monitor the input video stream of the person at the monitored location and to recognize and detect any abnormal activities by the person based on the one or more ML models trained by the ML model training engine 102. To recognize a detected new action/activity by the person, the abnormal activity detection engine 106 is configured to determine a sequence of embedding codes most similar to the skeletons of the trained one or more ML models of a normal activity. The abnormal activity detection engine 106 then analyzes whether a predetermined activity of the person is normal and routine by calculating the difference between the embedding codes of the best matching context among all of the possible contexts of the one or more trained ML models of the normal activity and the embedding codes of the newly detected activity, e.g., ∥all_transfered[best_context_index]−embedded_codes∥. The abnormal activity detection engine 106 is configured to identify the new activity as abnormal if the calculated difference is beyond a certain threshold. The abnormal activity detection engine 106 is then configured to alert an administrator at the monitored location about the recognized abnormal activity.

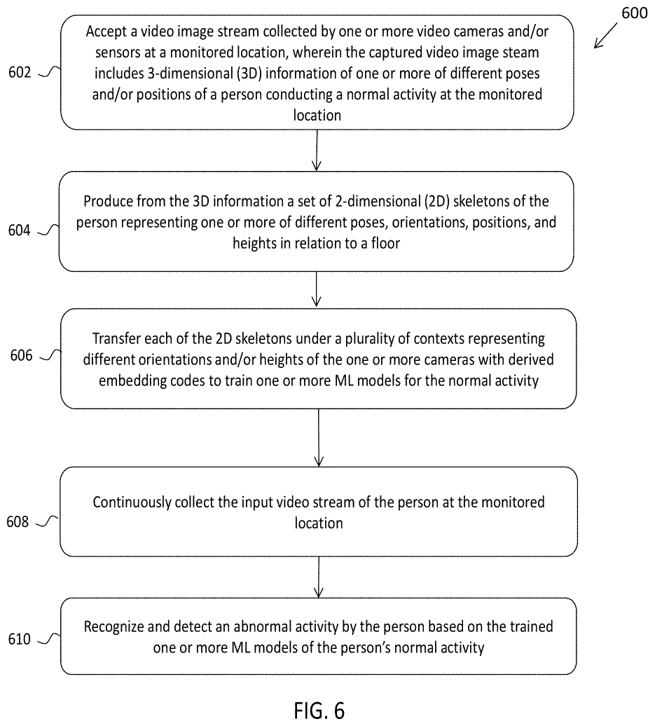

FIG. 6 depicts a flowchart 600 of an example of a process to support efficient machine learning model training. Although the figure depicts functional steps in a particular order for purposes of illustration, the processes are not limited to any particular order or arrangement of steps. One skilled in the relevant art will appreciate that the various steps portrayed in this figure could be omitted, rearranged, combined and/or adapted in various ways.

In the example of FIG. 6, the flowchart 600 starts at block 602, where a video image stream collected by one or more video cameras and/or sensors at a monitored location is accepted, wherein the captured video image stream includes 3-dimensional (3D) information of one or more of different poses and/or positions of a person conducting a normal activity at the monitored location. The flowchart 600 continues to block 604, where a set of 2-dimensional (2D) skeletons of the person representing one or more of different poses, orientations, positions, and heights in relation to a floor is produced from the 3D information. The flowchart 600 continues to block 606, where each of the 2D skeletons is transferred under a plurality of contexts representing different orientations and/or heights of the one or more cameras with derived embedding codes to train one or more ML models for the normal activity of the person. The flowchart 600 continues to block 608, where the input video stream of the person is continuously collected at the monitored location. The flowchart 600 ends at block 610, where an abnormal activity by the person is recognized and detected based on the trained one or more ML models of the person's normal activity.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

The methods and system described herein may be at least partially embodied in the form of computer-implemented processes and apparatus for practicing those processes. The disclosed methods may also be at least partially embodied in the form of tangible, non-transitory machine readable storage media encoded with computer program code. The media may include, for example, RAMs, ROMs, CD-ROMs, DVD-ROMs, BD-ROMs, hard disk drives, flash memories, or any other non-transitory machine-readable storage medium, wherein, when the computer program code is loaded into and executed by a computer, the computer becomes an apparatus for practicing the method. The methods may also be at least partially embodied in the form of a computer into which computer program code is loaded and/or executed, such that, the computer becomes a special purpose computer for practicing the methods. When implemented on a general-purpose processor, the computer program code segments configure the processor to create specific logic circuits. The methods may alternatively be at least partially embodied in a digital signal processor formed of application specific integrated circuits for performing the methods.

What is claimed is:

1. A method to support efficient machine learning (ML) model training, comprising:
accepting a video image stream collected by one or more video cameras and/or sensors at a monitored location, wherein the captured video image stream includes 3-dimensional (3D) information of one or more of different poses and positions of a person conducting a normal activity at the monitored location;
producing from the 3D information a set of 2-dimensional (2D) skeletons of the person representing one or more of different poses, orientations, positions, and heights in relation to a floor;
transferring each of the 2D skeletons under a plurality of contexts representing different orientations and/or heights of the one or more cameras with derived embedding codes to train one or more ML models for the normal activity of the person;
continuously monitoring the input video stream of the person at the monitored location; and
recognizing and detecting an abnormal activity by the person based on the trained one or more ML models of the person's normal activity.

2. A method to support efficient machine learning (ML) model training, comprising:
accepting a video image stream collected by one or more video cameras and/or sensors at a monitored location, wherein the captured video image stream includes 3-dimensional (3D) information of one or more of different poses and positions of a person conducting a normal activity at the monitored location;
producing from the 3D information a set of 2-dimensional (2D) skeletons of the person representing one or more of different poses, orientations, positions, and heights in relation to a floor; and
deriving an embedding code from each of the set of 2D skeletons under a plurality of contexts comprising different orientations and heights of the one or more cameras to train one or more ML models for the normal activity of the person,
wherein the plurality of contexts are invariant to the person and wherein the one more ML models are utilized to detect an abnormal activity of the person at the monitored location.

3. The method of claim 1, further comprising:
estimating in which of the plurality of contexts each of the plurality of skeletons is present in order to transfer each of the skeletons with the proper context.

4. The method of claim 1, further comprising:
identifying and marking a matching context as well as a sequence of the embedding codes for the one or more ML models to recognize the activity afterwards.

5. The method of claim 1, further comprising:
decoding the embedding codes to reconstruct the skeletons at the same or at a different position on the floor for backward loss propagation to determine training weights for the one or more ML models.

6. The method of claim 1, further comprising:
estimating height and orientation of each skeleton, wherein the height is presented as one component vector and the orientation is presented by a heatmap.

7. The method of claim 1, further comprising:
disentangling the positions on the floor and the poses of the person;
coding the 2D positions and the poses of the person into an embedding 8D code.

8. The method of claim 7, further comprising:
transforming the embedding 8D code to another space by a 8×8 matrix, which weights are trained by triplet loss on a pre-specified set of actions.

9. The method of claim 1, further comprising:
reconstructing the 3D information of the person's body in space based on the plurality of skeletons of the person.

10. The method of claim 1, further comprising:
adjusting one or more of orientation, height, and lens distortion of the camera used to capture the video stream to train the ML models.

11. The method of claim 10, further comprising:
analyzing each of the plurality of skeletons to predict a depth position of the person relative to the camera and generating scores for all possible postures of the person;
generating a projection of a center of mass of the person on the floor and the most relevant posture of the skeleton based on the analysis.

12. The method of claim 4, further comprising:
recognizing a new activity of the person by determining a sequence of embedding codes most similar to the skeletons of the trained one or more ML models of the normal activity;
analyzing whether the new activity of the person is normal and routine by calculating the difference between the sequence of embedding codes of the matching context of the one or more trained ML models of the normal activity and the sequence of the embedding codes of the new activity.

13. The method of claim 12, further comprising:
identifying the new activity as abnormal if the calculated difference is beyond a certain threshold.

14. A system to support efficient machine learning (ML) model training, comprising:
a ML model training engine configured to
accept a video image stream collected by one or more video cameras and/or sensors at a monitored location, wherein the captured video image stream includes 3-dimensional (3D) information of one or more of different poses and positions of a person conducting a normal activity at the monitored location;
produce from the 3D information a set of 2-dimensional (2D) skeletons of the person representing one or more of different poses, orientations, positions, and heights in relation to a floor;
transfer each of the 2D skeletons under a plurality of contexts representing different orientations and/or heights of the one or more cameras with derived embedding codes to train one or more ML models for the normal activity; and
an abnormal activity detection engine configured to
continuously collect the input video stream of the person at the monitored location;
recognize and detect an abnormal activity by the person based on the trained one or more ML models of the person's normal activity.

15. The system of claim 14, wherein:
the 2D skeletons of the person are each represented by a vector (X, Y), wherein X denotes the number of joints of the person and Y denotes the number estimated positions of the person at the monitored location as captured in the video stream.

16. The system of claim 14, wherein:
the embedding codes are independent of the position of the person on the floor at the monitored location.

17. The system of claim 14, wherein:
the ML model training engine is configured to identify and mark a matching context as well as a sequence of the embedding codes for the one or more ML models to recognize the activity afterwards.

18. The system of claim 14, wherein:
the ML model training engine is configured to decode the embedding codes to reconstruct the skeletons at the same or at a different position on the floor for backward loss propagation to determine training weights for the one or more ML models.

19. The system of claim 14, wherein:
the ML model training engine is configured to estimate height and orientation of each skeleton, wherein the height is presented as one component vector and the orientation is presented by a heatmap.

20. The system of claim 14, wherein:
the ML model training engine is configured to
disentangle the positions on the floor and the poses of the person;
code the 2D positions and the poses of the person into an embedding 8D code.

21. The system of claim 20, wherein:
the ML model training engine is configured to transform the embedding 8D code to another space by a 8×8 matrix, which weights are trained by triplet loss on a pre-specified set of actions.

22. The system of claim 14, wherein:
the ML model training engine is configured to reconstruct the 3D information of the person's body in space based on the plurality of skeletons of the person.

23. The system of claim 14, wherein:
the ML model training engine is configured to adjust one or more of orientation, height, and lens distortion of the camera used to capture the video stream to train the ML models to understand different variations of the person's posture.

24. The system of claim 14, wherein:
the ML model training engine is configured to
analyze each of the plurality of skeletons to predict a depth position of the person relative to the camera and generating scores for all possible postures of the person;
generate a projection of a center of mass of the person on the floor and the most relevant posture of the skeleton based on the analysis.

25. The system of claim 17, wherein:
the abnormal activity detection engine is configured to
recognize a new activity of the person by determining a sequence of embedding codes most similar to the skeletons of in the trained one or more ML models of the normal activity;
analyze whether the new activity of the person is normal and routine by calculating the difference between the embedding codes of the matching context of the one or more trained ML models of the normal activity and the embedding codes of the new activity.

26. The system of claim 25, wherein:
the abnormal activity detection engine is configured to identify the new activity as abnormal if the calculated difference is beyond a certain threshold.
